(19) United States
(12) Patent Application Publication
(10) Pub. No.: US 2008/0319935 A1
(43) Pub. Date: Dec. 25, 2008

(54) Systems & Methods to reduce wait time in the service sector and just in time demand management

(76) Inventor: Sanjeev Chandak, Fairfax, VA (US)

Correspondence Address: Sanjeev Chandak, 11811 Robertson Farm Cir, Fairfax, VA, 22030, US

(21) Appl. No.: 11/767,477

(22) Filed: Jun. 23, 2007

(51) Int. Cl. G06F 15/18; G06Q 30/00

(52) U.S. Cl. 706/45; 705/14

(57) ABSTRACT

Systems and Methods are provided to actively manage waiting time in the service sector where there is volatility in determining when exactly the service will be performed. In the service sector where buyers are waiting for service (for example Physician's Office, Hospital, Automobile Repair Shops, Restaurants, DMV offices, etc.), this method can be used to control the flow of customers so that they do not have to spend time in the waiting room for the next available service professional. The demand can be actively managed for just in time customer arrival to increase efficiency and satisfaction. This system can be monetized by providing “moment of truth” advertising at the point of service via the same mechanism used to communicate the waiting time or a different medium (including but not limited to mobile phone, PDA, internet, websites, email, phone call, SMS, etc.)

### BACKGROUND OF THE INVENTION

1. Field of the invention

The invention related to just in time demand management where the service provider has volatility and cannot guarantee the exact service time. The invention relates to managing customer flow in a service sector (which could be a physician's office, hospital, laboratory, dentist office, emergency room, outpatient services, restaurants, beauty parlors, auto repair shops, auto service shops, etc.). This invention would provide real time information so customers can arrive only a few minutes before service is most likely to be performed and do not have to wait at the service professional's place.

Currently there are different techniques used to manage customers. Some of these are like handing out pagers in restaurants, patients waiting in the waiting room, standing in a queue for service, Fastpass (Trademark, Disney Enterprises, Inc.) program in amusement parks, etc. They all have different limitations. There are also appointment reminder systems in the marketplace that remind a customer of their appointment either days or hours in advance.

Overall the service element of the provider is being enhanced so that customers are more satisfied.

### SUMMARY OF THE INVENTION

Presently customers have to wait for the service provider in some instances even when they have an appointment time. This is due to the fact the service provider cannot accurately estimate time of service days or months in advance.

This invention would allow customers to be informed in real time when the most likely service time will be. This will allow customers to spend their time elsewhere if they choose and arrive at the service location at the time of service resulting in a minimum wait time for the customer.

The systems are designed such that they interface with existing systems at the service provider, interface with central systems over the internet or wirelessly, publicly available information (for example traffic backups, maps, etc.) and then connects to the information device of the customer's choice (SMS, Cell phone application, MMS, Phone, Mail, Email, Website, etc.) All data transferred back and forth will have a high level of security so as not to compromise on the integrity & sanctity of personal information.

In addition, the information collected can be used to learn and provide better predictive algorithms and also help the provider improve efficiency.

Advertising is provided at the point of service via the same mechanism used to communicate the waiting time or a different medium (including but not limited to mobile phone, PDA, internet, websites, email, phone call, SMS, etc.). The advertisement algorithm incorporates all available information and then determines the best type of advertisement to deliver to the consumer.

### BRIEF DESCRIPTION OF THE SEVERAL VIEWS OF THE DRAWINGS

FIG. 1 is a flow diagram of the invention

FIG. 2 is a flowchart

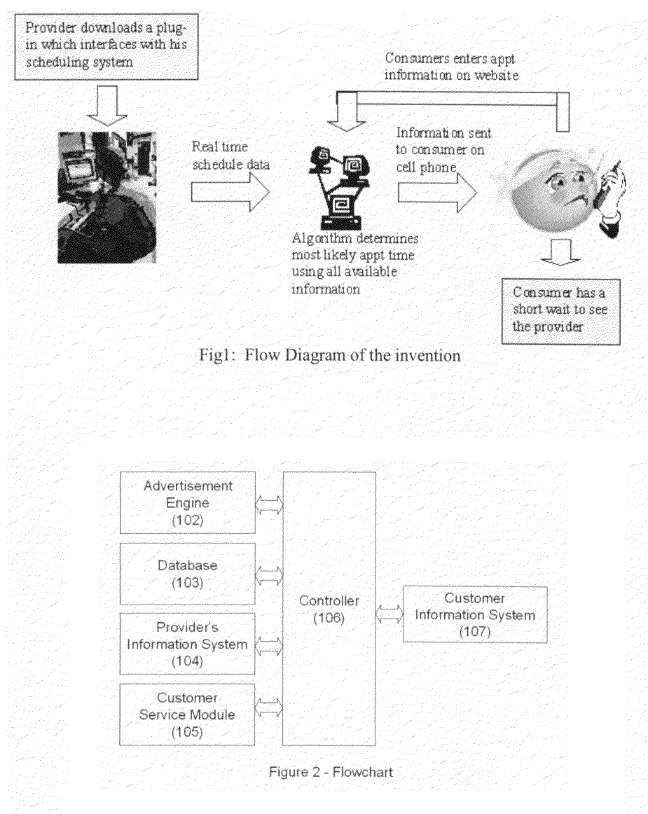

### DETAILED DESCRIPTION OF THE INVENTION

There are three main components

(A) Interface at the provider's location

(B) Customer information center

(C) Back office

(A) Interface at Provider's Location (104)

This will be a software program that will run in the background at the provider's location. Characteristics of the program include

(i) Downloadable, Self installable—can check what system the provider has and then load the applicable version

(ii) Runs in the background—potentially having 2 way communication with the scheduler or its database

(iii) Checks events in almost real time without user intervention and slowing the provider's system down

(iv) Transmit data securely (encrypted) to back office data servers through the internet. Also has the ability to get information from back office data servers and insert into the scheduler and or its database

(B) Customer Information Center (107)

The customer information center allows the customer to enter more demographical information as to provide a better service to the user. This is usually a website but could be other tools also. Alternatively, this information can be entered in a different manner also for example using cell phone, email, mail, etc. This allows the customer to interact with the provider's system and gather potential wait at different times and look at the provider's schedule. Also enables customer to enter an appointment time.

(C) Back Office

The back office would have servers/software that would have the following capabilities

(a) Database (103)—Has all the data stored about customers and service providers. Also has history information. Can be queried by the website or the advertising engine when needed.

(b) Controller (106)—This acts as the brain. The controller will schedule reminders, calculate potential delays and then send an update through the SMS engine or other mechanism. The controller is developed as both a scheduler and a program that would understand and respond to requests. For example if a customer sends a SMS to find out the shortest wait time near his zip code, the controller would select available providers within a predetermined radius, “ping” those offices to find out the wait time and then respond back to the cell phone (or other device) of the consumer with the information. It will communicate with the database, SMS engine and the advertisement engine. Ability to do things like quick surveys. Flexible and modular design so each “service” can be programmed and then offered to customers.

(c) SMS (or Information) Engine (107)—This will send and receive SMS to customers and provider's cell phones. Needs to be capable of sending multiple messages as part of a communication for example [receive an appointment request, send a list of potential options, receive a selected option and then send a confirmation back to the patient]. Different types of work flow can be created for each “service.” Would take input from the database, advertisement engine and controller. Same concept would work if the information device of the customer is not a cell phone—for example, use of a website etc.

(d) Advertisement Engine (102)—This will have access to the database and also requests from advertisers. Has rules to define what advertisement should be sent based on the demographics, advertiser, request, etc. Should be able to track history of advertisement sent and the responses. Would need to send all that information along with billing back to the database. Interfaces with the database, controller and SMS engine.

(e) Customer Service (105)—Service Representatives should be able to pull out information if a customer or a provider calls and asks information or needs help to set up the service. So a simple administrator page, where they can see all the information related to a patient or a doctor.

(f) Administration—Generate daily reports from the database on performance metrics

The design of the system is flexible so that it is used in other environments for example car service appointments, restaurant appointments, etc.

Advertisement Engine (102) is an intelligent system that analyzes advertiser requests, customer information, and service provider information and then selects the best advertisement suited for that particular situation.

Database (103), which is connected to other parts of the exemplary system of FIG. 2, may be implemented with a storage device, such as a high-density memory or storage device. Such a storage device may be implemented to provide the persistent storage of data. Database (103) may include a customer database for storing customer specific information or a provider database for including provider specific information or an advertiser database for including advertiser specific information. Database (103) may be either directly connected or integrated with the rest of the system, or it may be indirectly connected via a communication network, such as a local area network, or the Internet. Also, the data residing in the database may be distributed over various databases or tables

Provider Information System (104) in FIG. 2 is the system that the provider uses or may use to store, analyze and use information. In some cases, it can be a pen & paper system that is being used to set appointment times and then that data is entered electronically. It could be a scheduler or a database or a spreadsheet tool that the provider uses to organize his customer requests.

Customer Service Module (105) in FIG. 2 is a system that lets customer service representatives look at the history for a particular customer or provider and help them with their requests.

Controller (106) is a computer network with hardware and software that analyzes all available information and then takes a decision. It could involve neural networks programs for automatic learning. The controller may be a single computer or a network of computers and could either reside at one location or be distributed across the internet.

Customer Information System (107) in FIG. 2 may be a conventional cathode ray tube display, liquid crystal display, or any other display, such as a plasma display, which can display information. It could be a website, a cell phone, a mobile phone, a PDA, email readers, etc.

The system described above can use dedicated processor systems, micro controllers, programmable logic devices, wireless devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. Claims are made to all modifications and variation coming within the spirit and scope of the following claims.

What is claimed is:

1. A method to predict waiting time for customers/buyers in the service sector where there is volatility in determining the exact time of service. This method would look at past data of the service professional, information about the customers already waiting and ahead in queue to determine the most likely wait time for the customer. This time could either be an exact time or a small window wherein the service is most likely to be rendered. The method involves self learning (using neural networks, statistical modeling, etc.) based on prior history

2. The method of claim 1 wherein the customer already has a scheduled appointment time

3. The method of claim 1 wherein the service professional is a doctor or a physician or a health care provider

4. The method of claim 1 wherein the service provider is a hospital, emergency room, outpatient services, or a laboratory

5. The method of claim 1 wherein the service professional is in Automobile Repair Shops, Restaurants, or any other profession where customers have to wait in line for the service to be performed

6. A system to extract the relevant information from existing systems of the service professional (for example doctor scheduling systems). Use this data to predict the wait time as detailed in claim 1 and then delivering it to the customer via different mechanisms including mobile phone, PDA, internet, websites, email, phone call, SMS, etc. It utilizes intelligent reporting based on specific customer needs. Incorporates different customer attributes example departing address, traffic patterns at the time of the day, etc. to inform customer when he/she should leave the departing address in order to arrive on time at the service location. Offers real time information updates to the customer on when the service is most likely to be performed

7. The system of claim 6 wherein the customer already has a scheduled appointment time

8. The system of claim 6 wherein the service professional is a doctor or a physician or a health care provider

9. The system of claim 6 wherein the service provider is a hospital, emergency room, outpatient services, or a laboratory

10. The system of claim 6 wherein the service professional is in Automobile Repair Shops, Restaurants, or any other profession where customers have to wait in line for the service to be performed

11. The method of delivering targeted advertising at the time the service has/will be performed so as to deliver maximum value to the consumer & advertiser. The advertisement content would be determined by analyzing the specific situation of the buyer including type of service request, location, demographical information, and other information that is available. This advertisement can be delivered via multiple mechanisms (including but not limited to mobile phone, PDA, internet, websites, email, phone call, SMS, & mail). The advertisement could involve the use of coupons or offer numbers that can be redeemed at retailers.

12. The method of claim 11 wherein the customer already has a scheduled appointment time

13. The method of claim 11 wherein the service professional is a doctor or a physician or a health care provider

14. The method of claim 11 wherein the service provider is a hospital, emergency room, outpatient services, or a laboratory

15. The method of claim 11 wherein the service professional is in Automobile Repair Shops, Restaurants, or any other profession where customers have to wait in line for the service to be performed
